(19) United States
(12) Patent Application Publication
(10) Pub. No.: US 2019/0109621 A1
(43) Pub. Date: Apr. 11, 2019

(54) Multiple-phase multiple-input multiple-output detector and method thereof

(71) Applicant: REALTEK SEMICONDUCTOR CORPORATION, Hsinchu (TW)

(72) Inventors: DER-ZHENG LIU, Hsinchu County (TW); MING-YUH YEH, Taipei City (TW); YEN-CHIH CHEN, Hsinchu City (TW)

(21) Appl. No.: 16/134,231

(22) Filed: Sep. 18, 2018

(30) Foreign Application Priority Data
Oct. 5, 2017 (TW) 106134391

(51) Int. Cl. H04B 7/0413; H04L 1/00; H04L 1/20

(52) U.S. Cl. CPC H04B 7/0413; H04L 1/0054; H04L 1/206; H04L 1/0047

(57) ABSTRACT

A multiple-phase multiple-input multiple-output (MIMO) detector and a method thereof are disclosed. The multiple-phase MIMO detector includes a first MIMO detection module that performs a first MIMO detection operation on an input signal; a second MIMO detection module that is coupled in series with the first MIMO detection module and performs a second MIMO detection operation on the input signal; and a control module that is coupled to the second MIMO detection module and controls whether the second MIMO detection module operates. Complexity of the first MIMO detection module is lower than or equal to that of the second MIMO detection module.

### BACKGROUND OF THE INVENTION

### 1. Field of the Invention

The present invention generally relates to multiple-input multiple-output (MIMO) technology and, more particularly, to a MIMO detector and a MIMO detection method.

### 2. Description of Related Art

Multiple-input multiple-output (MIMO) technology, which employs an antenna array to transmit and receive signals, can increase channel capacity under existing spectrum resources, resist signal attenuation caused by multipath, and increase communication coverage. Current wireless communication standards, such as IEEE 802.11n (or 11ac, 11ax, etc.) used by wireless local area networks, IEEE 802.16 used by Worldwide Interoperability for Microwave Access (WiMax), and the Long Term Evolution (LTE) system proposed by the 3rd Generation Partnership Project, (3GPP), use MIMO technology to improve throughput. On the other hand, high order modulation scheme with Quadrature Amplitude Modulation (QAM) is also widely used in the above wireless communication standards.

In general, MIMO detection methods include linear and nonlinear detection methods. The linear MIMO detection method includes algorithms of Zero-Forcing (ZF) and minimum mean-square error (MMSE). The nonlinear MIMO detection method includes algorithms of Vertical Bell Laboratories Layered Space Time (V-BLAST), Maximum Likelihood (ML), and sphere decoding (SD). Compared with the linear detection method, the nonlinear detection method has higher performance at the expense of higher complexity. In particular, with the higher order modulation scheme, the nonlinear detection method has higher complexity, requires larger circuit area, and consumes greater power.

Here are some modulation schemes commonly employed in the wireless communication systems: binary phase-shift keying (BPSK), quadrature phase-shift keying (QPSK), QAM (including 16-QAM, 64-QAM, 256-QAM and 1024-QAM, etc.) and so on. Therefore, the design of MIMO detectors has become more and more complicated, so MIMO detectors that can adapt to various modulation schemes are needed.

### SUMMARY OF THE INVENTION

In view of the issues of the prior art, an object of the present invention is to provide a multiple-phase multiple-input multiple-output (MIMO) detection method and a related MIMO detector that are used in a receiver and applicable to various modulation schemes, so as to make an improvement to the prior art.

A multiple-phase MIMO detector is provided. The multiple-phase MIMO detector includes a first MIMO detection module, a second MIMO detection module, and a control module. The first MIMO detection module is configured to perform a first MIMO detection operation on an input signal. The second MIMO detection module is coupled in series with the first MIMO detection module and configured to perform a second MIMO detection operation on the input signal. The control module is coupled to the second MIMO detection module and configured to control whether the second MIMO detection module operates. Complexity of the first MIMO detection module is lower than or equal to complexity of the second MIMO detection module.

A multiple-phase MIMO detector supporting a highest order modulation scheme with M-QAM is provided. M is an integer greater than one. The multiple-phase MIMO detector includes a first MIMO detection module and a second MIMO detection module. The first MIMO detection module is configured to perform a first MIMO detection operation on an input signal. The first MIMO detection module supports M-QAM. The second MIMO detection module is coupled in series with the first MIMO detection module and configured to perform a second MIMO detection operation on the input signal. The second MIMO detection module supports N-QAM, and N is an integer greater than 1 and smaller than M. Complexity of the first MIMO detection operation is lower than or equal to complexity of the second MIMO detection operation, and a modulation scheme of the input signal includes the M-QAM and the N-QAM.

A multiple-phase MIMO detection method applied to a MIMO wireless device that receives an input signal is provided. The method includes steps of: performing a first MIMO detection operation on the input signal; and determining, according to reference information, whether to perform a second MIMO detection operation on the input signal. Complexity of the first MIMO detection operation is lower than or equal to complexity of the second MIMO detection operation. The reference information is selected from a group consisting of a Log-likelihood ratio distribution, a tree pruning ratio, the number of constellation candidates with bounded distance, a condition number of channel matrix, a signal-to-noise power ratio of the input signal, a packet error rate of the input signal, a bit error rate of the input signal, a modulation and coding scheme of the input signal, a constellation size of the input signal, and the number of antennas of the MIMO wireless device.

By performing MIMO detection operations in two phases or more, the multiple-phase MIMO detector and its associated detection method of the present invention are more flexible in operations. Compared with the prior art, the present invention effectively reduces the circuit size required and effectively controls power consumption.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 illustrates a functional block diagram of a MIMO wireless device of the present invention.

FIG. 2 illustrates a functional block diagram of the logic circuit 122 according to an embodiment of the present invention.

FIG. 3 illustrates a flowchart of a MIMO detection method according to an embodiment of the present invention.

FIG. 4 illustrates a detailed flow of step S340 of FIG. 3.

FIG. 5 illustrates a detailed flow of step S430 of FIG. 4.

### DETAILED DESCRIPTION OF THE EMBODIMENTS

The following description is written by referring to terms of this technical field. If any term is defined in this specification, such term should be explained accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes multiple-phase multiple-input multiple-output (MIMO) detectors and the associated detection method. On account of that some or all elements of the multiple-phase MIMO detectors could be known, the detail of such elements is omitted provided that such detail has little to do with the features of this disclosure and this omission nowhere dissatisfies the specification and enablement requirements.

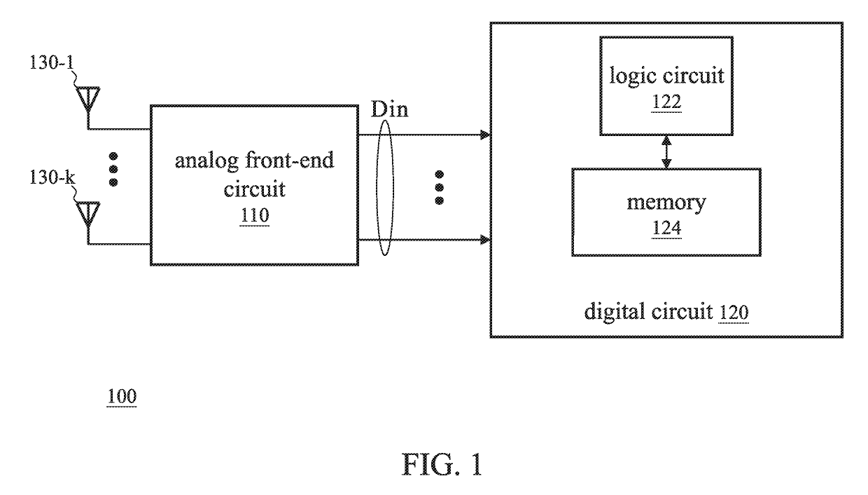

FIG. 1 is a functional block diagram of a MIMO wireless device of the present invention. The MIMO wireless apparatus 100 includes an analog front-end circuit 110 and a digital circuit 120. The analog RF signal is received by the k antennas (130-1 to 130-k, k is an integer greater than or equal to 2) and then processed by the analog front-end circuit 110, which, depending on different applications, may include a part or all of the following operations: down-conversion, amplification, filtering, sampling, analog-to-digital conversion, etc., but not limited thereto, to generate a digital input signal Din. The digital circuit 120 then processes the digital input signal Din to obtain the data signal carried by the digital input signal Din. The digital circuit 120 includes a logic circuit 122 (or an equivalent device having program execution capabilities such as a processing unit, a microprocessor, a microcontroller, etc.) and a memory 124. The memory 124 stores programs codes and/or program instructions that can be executed by the logic circuit 122. The digital circuit 120 performs related logic operations according to a reference clock.

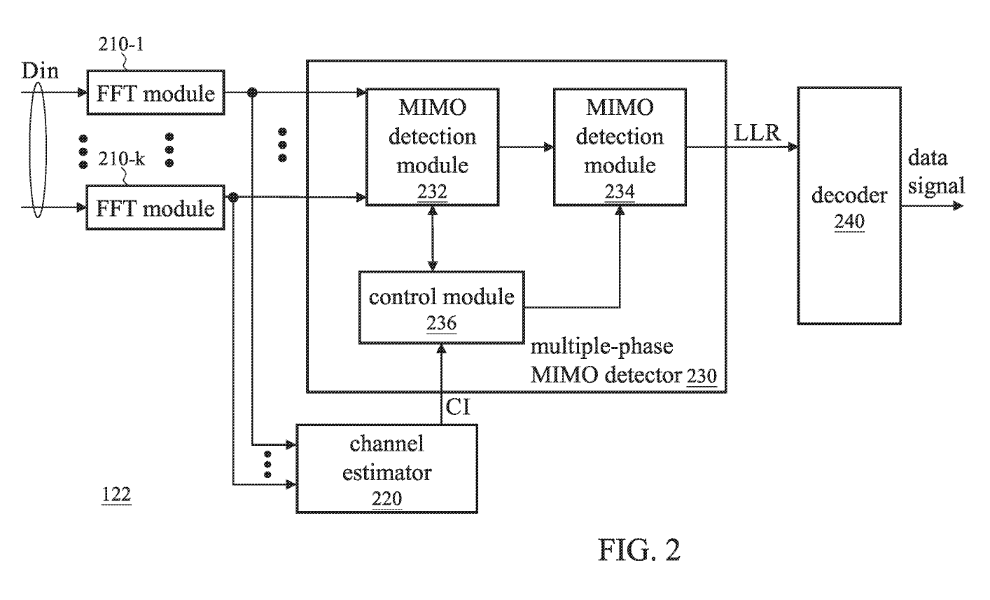

According to its detailed functions, the logic circuit 122 may be divided into multiple functional modules. FIG. 2 is a functional block diagram of the logic circuit 122 according to an embodiment of the present invention. After the digital input signal Din are converted to the frequency domain by the k Fast Fourier Transform (FFT) modules 210-1 to 210-k, the multiple-phase MIMO detector 230 detects the digital input signal Din to obtain multiple log-likelihood ratios (LLRs) corresponding to the digital input signal Din. The higher the LLR value, the higher the probability of being correct (reliability) is. The decoder 240 can decode the data signal carried by the digital input signal Din based on the LLR. The channel estimator 220 can perform channel estimation for the radio frequency signals according to the digital input signal Din and thus generates channel quality information CI. In addition to the control module 236, the multiple-phase MIMO detector 230 includes MIMO detection modules of two phases or more. An embodiment of two phases is illustrated in FIG. 2, with the first phase being the MIMO detection module 232 and the second phase being the MIMO detection module 234. The MIMO detection module 234 is coupled in series with and arranged behind the MIMO detection module 232. In this embodiment, information (such as the channel quality information CI) required by the MIMO detection module 232 and MIMO detection module 234 may be provided by the control module 236. In other embodiments, both the MIMO detection module 232 and MIMO detection module 234 may obtain the information required without the involvement of the control module 236. In some embodiments, the complexity of the MIMO detection module 232 is lower than the complexity of the MIMO detection module 234. In the above embodiment, the MIMO detection module 232 and the MIMO detection module 234 may be respectively a linear MIMO detection module (e.g., a Zero-Forcing (ZF) detection module or a Minimum Mean Square Error (MMSE) detection module) and a nonlinear MIMO detection module (e.g., a Sphere Decoding (SD) detection module). Alternatively, both the MIMO detection module 232 and the MIMO detection module 234 may be nonlinear MIMO detection modules. In other embodiments, the MIMO detection module 232 and the MIMO detection module 234 are the same MIMO detection module, and, in this case, the complexity of the MIMO detection module 232 is equal to the complexity of the MIMO detection module 234. For example, both the MIMO detection module 232 and the MIMO detection module 234 are SD detection modules, but the MIMO detection module 232 and the MIMO detection module 234 have different candidate lists (i.e., they process different constellation points).

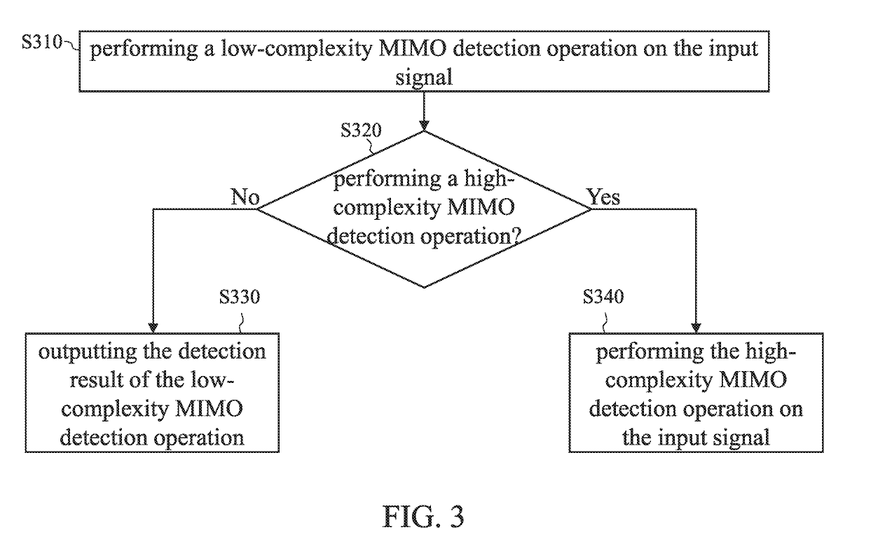

FIG. 3 is a flowchart of a MIMO detection method according to an embodiment of the present invention. Please refer to FIG. 2 and FIG. 3 for operation details of the of the multiple-phase MIMO detector 230. The MIMO detection module 232 of the multiple-phase MIMO detector 230 performs a low-complexity MIMO detection operation on the digital input signal Din (step S310) to generate a detection result. The detection result may be transmitted to the MIMO detection module 234 and/or the control module 236. Then, the control module 236 decides whether to perform a high-complexity MIMO detection operation on the digital input signal Din (step S320). When the determination result of step S320 is negative, the control module 236 controls the MIMO detection module 234 not to operate, so that the multiple-phase MIMO detector 230 directly outputs the detection result of the MIMO detection module 232 (i.e., the detection result of the low-complexity MIMO detection operation) (step S330). More specifically, in step S330 the multiple-phase MIMO detector 230 does not perform the high-complexity MIMO detection operation on the digital input signal Din, which reduces the processing time and power consumption of the digital circuit 120. When the determination result of step S320 is positive, the control module 236 controls the MIMO detection module 234 to perform the high-complexity MIMO detection operation on the digital input signal Din (step S340).

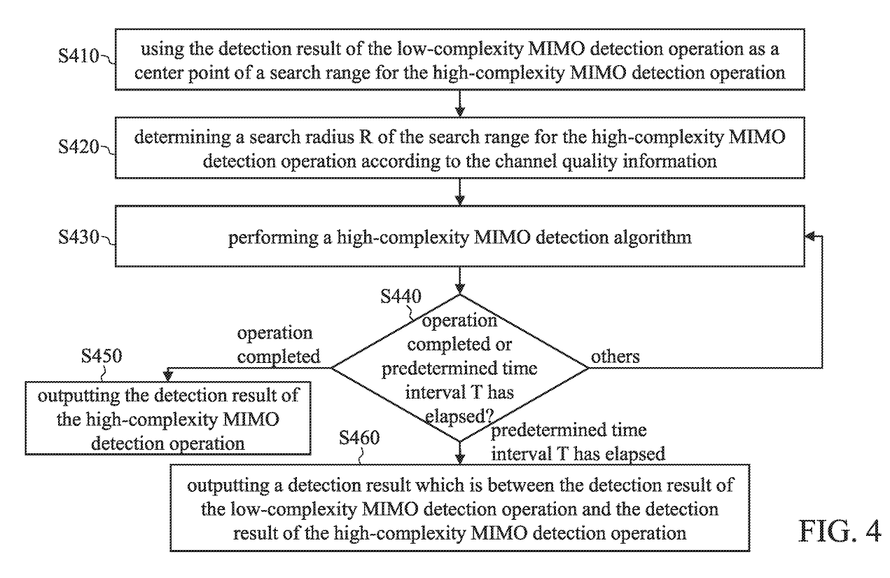

Reference is made to FIG. 4, which shows a detailed flow of step S340 of FIG. 3. When the high-complexity MIMO detection operations are being performed, the MIMO detection module 234 uses the detection result of the MIMO detection module 232 (which can be referred to as the “first-phase LLR”) as a center point of a search range for the high-complexity MIMO detection operation (step S410) and determines a search radius R of the search range according to the channel quality information CI that is generated by the channel estimator 220 and may be provided by, for example but not limited to, the control module 236 (Step S420). Then, the MIMO detection module 234 determines a candidate list based on the center point and the search radius R and performs a high-complexity MIMO detection algorithm on the constellation points in the candidate list (step S430). As a result, the high-complexity MIMO detection operation can find better constellation points within a limited range. Compared to the process of performing the high-complexity MIMO detection operation on all the constellation points, steps S410 to S430 can reduce the computational complexity of a high-complexity MIMO detection operation, thereby reducing the overall power consumption of the circuit.

Continuing to examine FIG. 4. When the MIMO detection module 234 performs the high-complexity MIMO detection algorithm, the control module 236 monitors whether the MIMO detection module 234 completes the operation within a predetermined time interval T (step S440). When the operation has not been completed and the predetermined time interval T has not elapsed, the process returns to step S430 to continue the operation. When the MIMO detection module 234 has completed the operation and generated accordingly a detection result (which can be referred to as the “second-phase LLR”) before the predetermined time interval T has elapsed, the multiple-phase MIMO detector 230 outputs a detection result of the high-complexity MIMO detection operation (step S450). When the predetermined time interval T has elapsed but the operation has not been completed, the control module 236 interrupts the operation of the MIMO detection module 234 (in this instance, despite being interrupted, the MIMO detection module 234 still generates a detection result, which can be referred to as the “second-phase LLR′”), and controls the multiple-phase MIMO detector 230 to output the detection result (i.e., the second-phase LLR′, which has been generated before the interruption of the MIMO detection module 234) (step S460). The value of the second-phase LLR′ is between the first-phase LLR and the second-phase LLR, that is, the first-phase LLR<the second-phase LLR′<the second-phase LLR. In order to ensure that the overall operating time of the multiple-phase MIMO detector 230 conforms to the timing of the MIMO wireless device 100, the predetermined time interval T can be designed to be less than or equal to the time interval between two consecutive detection results of the MIMO detection module 232, or less than or equal to the operation cycle of the circuit in the next stage. When the circuit in the next stage is the decoder 240, the multiple-phase MIMO detector 230 needs to provide a new LLR during each operation cycle of the decoder 240 to ensure that the decoder 240 can proceed to decode. In an embodiment, the predetermined time interval T is a multiple of the cycle of the reference clock of the digital circuit 120 that includes the multiple-phase MIMO detector 230 and the decoder 240.

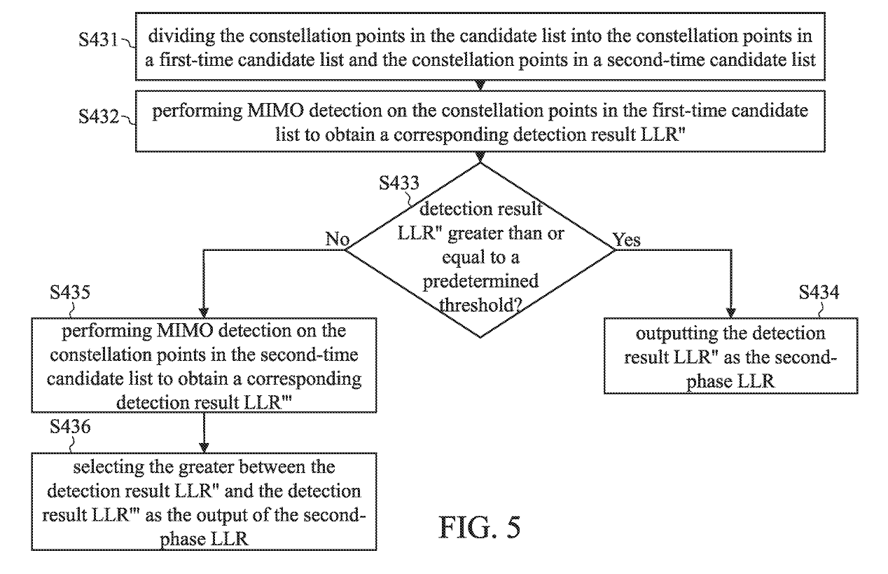

In another embodiment, the MIMO detection module 234 can be designed as another two-phase detection. In this embodiment, step S430 can further include the following steps, as shown in FIG. 5. First, the constellation points in the candidate list in step S430 are divided into the constellation points in a first-time candidate list and the constellation points in a second-time candidate list (step S431). The number of the constellation points in the first-time candidate list is smaller than the number of the constellation points in the candidate list. The MIMO detection module 234 first performs MIMO detection on the constellation points in the first-time candidate list to obtain a corresponding detection result, which is referred to as LLR″ (step S432). Then the detection result LLR″ is compared with a predetermined threshold (step S433). If the value of the detection result LLR″ is greater than or equal to the predetermined threshold, the MIMO detection module 234 outputs the detection result LLR″ as the second-phase LLR (step S434). If the value of the detection result LLR″ is smaller than the predetermined threshold, MIMO detection is performed again on the constellation points in the second-time candidate list to obtain a corresponding detection result, which is referred to as LLR′″ (step S435). The MIMO detection module 234 selects the greater between the detection result LLR″ (the result of step S432) and the detection result LLR′″ (the result of step S435) as the output of the second-phase LLR (step S436). In this way, the two-phase (multiple-phase) high-complexity MIMO detection is completed.

Of course, the first-time candidate list may be determined in various ways depending on the feasibility and convenience of the circuit design and the consideration of costs. In one embodiment, the MIMO detection module 234 first determines a first radius R1 according to the search radius R determined in step S420. R1 is smaller than R. The MIMO detection module 234 determines the first-time candidate list by using the center point obtained in step S410 as the center and the first radius R1 as the search radius and determines the second-time candidate list by using the center point obtained in step S410 as the center and the search radius R determined in step S420 as the search radius, with the first-time candidate list deducted. Of course, the operation cycle of the above-mentioned high-complexity second-phase MIMO detection module 234 is not greater than the predetermined time interval T.

Reference is made to FIG. 3. In step S320, the control module 236 determines whether the MIMO detection module 234 operates according to the internal parameters and/or the external parameters of the multiple-phase MIMO detector 230. When the MIMO detection module 234 is not operating, the multiple-phase MIMO detector 230 directly outputs the detection result of the MIMO detection module 232 (i.e., in this instance, the MIMO detection module 234 can be regarded as being bypassed or disabled). When the MIMO detection module 234 operates, the multiple-phase MIMO detector 230 outputs the detection result of the MIMO detection module 234 (the detailed flow is shown in FIG. 4). In other words, the multiple-phase MIMO detector 230 of the present invention is designed to certainly control the MIMO detection module 232 to operate (that is, in the present invention, the low-complexity MIMO detection operation is certainly performed when the MIMO detection is being performed), and to optionally control, according to the internal parameters and/or external parameters, the MIMO detection module 234 to operate (that is, in the present invention, the high-complexity MIMO detection operation is selectively performed when the MIMO detection is being performed). This design can be regarded as an early termination mechanism for the multiple-phase MIMO detector 230, which can prevent the MIMO wireless device 100 from investing resources (e.g., time, power) with no better outcome obtained. The early termination mechanism helps improve the performance of the MIMO wireless device 100. The above internal parameters are information from the multiple-phase MIMO detector 230, and the above-mentioned external parameters are information not from the multiple-phase MIMO detector 230.

The above internal parameters may be the detection results that the multiple-phase MIMO detector 230 generates according to several previous symbols, such as the LLR distribution, the tree pruning ratio, and/or the number of constellation candidates with bounded distance. The above internal parameters may also include the predetermined time interval T used in the foregoing step S440 to ensure that the multiple-phase MIMO detector 230 outputs its detection result within the predetermined time interval T (i.e., outputs the most likely solution that can be obtained within a limited time period). The external parameters include at least one of the followings: the condition number of channel matrix, the signal-to-noise power ratio (SNR) of the input signal, the packet error rate (PER) of the input signal, the bit error rate (BER) of the input signal, the modulation and coding scheme (MCS) of the input signal, the constellation size of the input signal, and the number of antennas of the MIMO wireless device 100 (i.e., the aforementioned k value).

Taking the MCS as an example, when the digital input signal Din has a higher order modulation scheme with QAM, higher density is present in the constellation coordinate. That is, increasing the constellation points while the average energy of the constellation remains unchanged renders the distances between the constellation points smaller. The inventors observed that in a case where the quality of the channel through which the symbols are transmitted is good, the value of the detection result of the MIMO detection module 232 (the first-phase LLR) is very high, indicating that the probability of the MIMO detection module 232 being correct (i.e., the reliability of the MIMO detection module 232) is also very high. Therefore, in the case where the channel quality is good, the performance of the MIMO detection module 232 is close to the performance of a combination of the MIMO detection module 232 and the MIMO detection module 234 that are coupled in series. The better the channel quality, the higher the transmission rate employed by the MCS becomes (that is, the higher the order modulation scheme). In other words, the higher order modulation scheme implies a better channel quality. In addition, by using the higher order modulation scheme, the higher the calculation complexity becomes, leading to a larger circuit size and greater power consumption. Therefore, in some embodiments, the highest order modulation scheme that the MIMO detection module 234 supports is designed to be lower than the highest order modulation scheme needed to be supported to meet the related standards. That is, for example, if the MIMO wireless device 100 supports M-QAM, the MIMO detection module 234 is designed not to support M-QAM, M being an integer greater than 1. For example, if the highest order modulation scheme needs to be supported to meet the 802.11ax standard is 1024-QAM, the circuit of the MIMO detection module 234 can be designed to support a highest order modulation scheme with 256-QAM or 64-QAM only. In other words, the control module 236 uses the MCS of the digital input signal Din as a control condition to determine the operating mechanism of the entire multiple-phase MIMO detector 230. In another embodiment, when the MCS is greater than or equal to 1024-QAM or 256-QAM, the multiple-phase MIMO detector 230 uses only the detection result of the low-complexity MIMO detection module 232 as the output; when the MCS is smaller than 1024-QAM or 256-QAM, the multiple-phase MIMO detector 230 uses the detection result of the combination of the MIMO detection module 232 and the MIMO detection module 234 that are coupled in series as the output. Such a design can effectively reduce the circuit size required and effectively control the power consumption, and its performance is only slightly lower than the conventional high-complexity MIMO detection operation.

In different embodiments, the elements included in FIG. 2 may be implemented with hardware (e.g., circuitry), software, and/or firmware. The present invention can be applied to wireless and wired MIMO devices.

The FFT module 210, the MIMO detection module 232, the MIMO detection module 234, and the control module 236 can be implemented by hardware, software, and/or firmware. When these modules are implemented by software or firmware, the logic circuit 122 may be or utilize a processor, a controller, a micro control unit (MCU) or the like to execute the program codes or instructions stored in the memory 124 to perform the functions of each module.

Please note that there is no step sequence limitation for the method inventions as long as the execution of each step is applicable. Furthermore, the shape, size, and ratio of any element and the step sequence of any flow chart in the disclosed figures are exemplary for understanding, not for limiting the scope of this invention. The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A multiple-phase multiple-input multiple-output (MIMO) detector, comprising:
a first MIMO detection module configured to perform a first MIMO detection operation on an input signal;
a second MIMO detection module coupled in series with the first MIMO detection module and configured to perform a second MIMO detection operation on the input signal, wherein complexity of the first MIMO detection module is lower than or equal to complexity of the second MIMO detection module; and
a control module coupled to the second MIMO detection module and configured to control whether the second MIMO detection module operates.

2. The multiple-phase MIMO detector of claim 1, wherein whether the second MIMO detection module operates is controlled by the control module according to first information generated by the multiple-phase MIMO detector corresponding to at least one previous symbol.

3. The multiple-phase MIMO detector of claim 2, wherein the first information comprises at least one of a Log-likelihood ratio distribution, a tree pruning ratio, and the number of constellation candidates with bounded distance.

4. The multiple-phase MIMO detector of claim 1, wherein the multiple-phase MIMO detector is applied to a wireless device, and whether the second MIMO detection module operates is controlled by the control module according to second information not generated by the multiple-phase MIMO detector; wherein the second information comprises at least one of a condition number of channel matrix, a signal-to-noise power ratio, a packet error rate, a bit error rate, a constellation size, a modulation and coding scheme (MCS), and the number of antennas of the wireless device.

5. The multiple-phase MIMO detector of claim 1, wherein the multiple-phase MIMO detector is used for a plurality of modulation schemes comprising a highest-order modulation scheme, and wherein when a modulation scheme of the input signal is the highest-order modulation scheme, the control module controls the second MIMO detection module not to operate.

6. The multiple-phase MIMO detector of claim 5, wherein the highest-order modulation scheme is M-Quadrature Amplitude Modulation (QAM), wherein M is an integer greater than or equal to 256t.

7. The multiple-phase MIMO detector of claim 5, wherein the second MIMO detection module is not used for the highest-order modulation scheme.

8. The multiple-phase MIMO detector of claim 6, wherein the second MIMO detection module is used for N-QAM, N being an integer greater than 1 and smaller than M.

9. The multiple-phase MIMO detector of claim 1, wherein the second MIMO detection module is a nonlinear MIMO detection module, and the first MIMO detection module is a linear MIMO detection module or a nonlinear MIMO detection module.

10. The multiple-phase MIMO detector of claim 1, further comprising
a channel estimator coupled to the control module and configured to generate channel quality information according to the input signal;
wherein the first MIMO detection module generates a detection result, and the second MIMO detection module uses the detection result as a center point of a search range;
wherein the second MIMO detection module determines a search radius according to the channel quality information.

11. A multiple-phase multiple-input multiple-output (MIMO) detector, the multiple-phase MIMO detector for a plurality of modulation schemes comprising M-Quadrature Amplitude Modulation (QAM) and N-QAM, N being an integer greater than one, M being an integer greater than N, the multiple-phase MIMO detector comprising:
a first MIMO detection module configured to perform a first MIMO detection operation on an input signal, wherein the first MIMO detection module is used for N-QAM and M-QAM; and
a second MIMO detection module coupled in series with the first MIMO detection module and configured to perform a second MIMO detection operation on the input signal, wherein the second MIMO detection module is used for N-QAM and not used for M-QAM;
wherein complexity of the first MIMO detection operation is lower than or equal to complexity of the second MIMO detection operation.

12. The multiple-phase MIMO detector of claim 11, wherein M is greater than or equal to 256.

13. The multiple-phase MIMO detector of claim 11, wherein the first MIMO detection module generates a detection result, the second MIMO detection module uses the detection result as a center point of a search range, and the second MIMO detection module determines a search radius according to channel quality information.

14. The multiple-phase MIMO detector of claim 11, wherein the second MIMO detection module is a nonlinear MIMO detection module, and the first MIMO detection module is a linear MIMO detection module.

15. A multiple-phase multiple-input multiple-output (MIMO) detection method, applied to a MIMO wireless device that receives an input signal, for a plurality of modulation schemes, the multiple-phase MIMO detection method comprising:
performing a first MIMO detection operation on the input signal to generate a first MIMO detection signal; and
determining, according to reference information, whether to perform a second MIMO detection operation on the input signal according to the first MIMO detection signal;
wherein complexity of the first MIMO detection operation is lower than or equal to complexity of the second MIMO detection operation;
wherein the reference information is selected from a group comprises a Log-likelihood ratio distribution, a tree pruning ratio, the number of constellation candidates with bounded distance, a condition number of channel matrix, a signal-to-noise power ratio, a packet error rate, a bit error rate, a modulation and coding scheme (MCS), a constellation size, and the number of antennas of the MIMO wireless device.

16. The detection method of claim 15, wherein the plurality of modulation schemes comprises a highest-order modulation scheme, wherein when a modulation scheme of the input signal is the highest-order modulation scheme, the method determines not to perform the second MIMO detection operation on the input signal.

17. The detection method of claim 16, wherein the highest-order modulation scheme is M-Quadrature Amplitude Modulation (QAM), and M is greater than or equal to 256.

18. The detection method of claim 15, wherein the first MIMO detection operation is used for M-Quadrature Amplitude Modulation (QAM), and the second MIMO detection operation is not used for the M-QAM, M being an integer greater than 1.

19. The detection method of claim 18, wherein the second MIMO detection operation is used for N-QAM, and N is an integer greater than 1 and smaller than M.
